(19) United States
(12) Patent Application Publication
(10) Pub. No.: US 2014/0234600 A1
(43) Pub. Date: Aug. 21, 2014

(54) COMPOSITE LAMINATE HAVING IMPROVED IMPACT STRENGTH AND THE USE THEREOF

(71) Applicant: E I DU PONT DE NEMOURS AND COMPANY, Wilmington, DE (US)

(72) Inventors: Yong Wang, Shanghai (CN); Haihua Shen, Hangzhou (CN); Yongchao Ma, Shanghai (CN)

(73) Assignee: E I Du Pont DE Nemours and Company, Wilmington, DE (US)

(21) Appl. No.: 14/351,155

(22) PCT Filed: Oct. 15, 2012
(86) PCT No.: PCT/US2012/060300

§ 371 Date: Apr. 11, 2014

(30) Foreign Application Priority Data
Oct. 14, 2011 (CN) 201110317035.4

(51) Int. Cl. B32B 5/26

(52) U.S. Cl. CPC B32B 5/26; B32B 2260/023; B32B 2260/046; B32B 2262/0269; B32B 2262/106; B32B 2307/558
USPC 428/212; 442/219; 428/220; 156/60; 156/285

(57) ABSTRACT

A composite laminate having improved impact strength, which comprises: a multilayer carbon fiber fabric, wherein said carbon fiber fabric may be a bidirectional weave or a unidirectional weave; a multilayer nonwoven mat, wherein said nonwoven mat is made of para-aramid; and cured epoxy resin, wherein said cured epoxy resin is made of the epoxy resin system designed for impregnation that immersed in the carbon fiber fabric layer and at least one layer of the nonwoven mat is sandwiched between two layers of carbon fiber fabric layer and both outer surface layers of the composite laminate are carbon fiber fabric layer.

### BACKGROUND OF THE INVENTION

1. Field of the Invention

The present invention relates to a composite material of carbon fiber reinforced polymer, more specifically, the invention relates to a composite laminate of carbon fiber reinforced polymer having improved impact strength, the preparation method and the use thereof.

2. Description of the Related Art

Carbon fiber reinforced polymer (CFRP) is made from high strength and high modulus carbon fibers and epoxy resin base material, which offer a very attractive combination of high specific strength and modulus (ratio of strength or modulus to density), outstanding thermal stability, good corrosion resistance and is therefore widely used in transportation, sporting goods equipment, or other fields that requires lightweight and high strength structural component materials. With a gradual increase in the demand for energy consumption reduction, especially in the field of transportation, the use of carbon fiber reinforced polymer materials to replace metal materials as the component materials in light vehicles, high-speed trains, as well as commercial aircraft has become increasingly common. In a society with increased environmental awareness, promotion of the application of carbon fiber reinforced polymer materials will also become increasingly important.

For the major application areas of carbon fiber reinforced polymer materials, one of the important properties required is that structural integrity can be maintained even when faced with unexpected shocks or hit. Especially when considering the use of carbon fiber reinforced polymer material as the structural components of a vehicle for the purpose to reduce weight, it is extremely critical to make sure the structural components made from carbon fiber reinforced polymer will give similar or same protection efforts as the components made from conventional steel or aluminum. Compared with other high-performance fibers, such as composite material made from para-aramid fibers or glass fibers, Carbon fiber reinforced polymer material offer a high specific strength and modulus but relatively poorer impact strength, thus limiting the promotion of the application of carbon fiber reinforced polymer materials. Today in the composite materials industry, people generally suggest two ways to improve the impact strength of carbon fiber reinforced polymer material: (1) increase the thickness of the carbon fiber reinforced polymer material, but at the same time also increase the final weight and cost of the component; (2) use the carbon fiber-reinforced polymer material in combination with other high performance fibers with better impact resistance performance, wherein said high performance fibers with better impact resistance performance including para-aramid fibers or glass fibers. However, such a fibrous material combination still has the problem that it increases the total weight and thickness of the final product.

Canadian Patent Application No. CA25454981 discloses a composite laminate used in sporting goods equipment, wherein said composite laminate comprises (a) a composite material layer that is pre-impregnated with a plurality of fiber-containing resins as the outer layer, and (b) a pre-impregnated fiber layer with higher stiffness that sandwiched in between the composite material layer that pre-impregnated with a plurality of fiber-containing resins as the core layer. The fiber of said composite material layer that is pre-impregnated with the resin as the outer layer comprises high-performance fibers such as glass fiber, Kevlar® fiber, Vectran® fiber, etc., wherein said fiber can be woven or nonwoven; the fiber used as the core layer can be selected from high-performance fibers such as carbon fibers, graphite fibers, or glass fibers mixed with carbon fibers. Said composite laminate generally comprises 1-6 layers of said core layer (preferably a carbon fiber layer) and 4-12 layers of said outer layer of the composite material layer (preferably is glass fiber layer), the thickness of said composite laminate is usually 4-30 mm.

U.S. Pat. No. 6,995,099 B1 discloses a composite material of fiber reinforced polymeric material, wherein said composite material comprises (a) a sheet-shaped fiber reinforced polymeric material layer, and (b) a nonwoven layer laminated on at least one side of the fiber reinforced polymeric material layer; wherein the fiber used in said fiber reinforced polymeric material layer having a high strength and high elasticity modulus, such as glass fibers, para-aramid fibers, carbon fibers, preferably is carbon fiber, the layer can be a unidirectional knitted fabric, bi-directional knitted fabric or stitch cloth; the fiber of said nonwoven layer comprise nylon 6, nylon 66, vinylon, para-aramid, polyester, polyethylene, and the like. Of these fibers, nylon 6 and nylon 66 having high crystallinity are preferred. This patent discloses three ways for the integration of layer (a) and layer (b), the first way is using short fibers in the layer (b), wherein the short fiber of layer (b) is passed through layer (a) by, for example, needle punching method to integrate layer (a) with layer (b); the second way is integrate layer (a) and layer (b) by using the pressure sensitive adhesive; and third way is by adding low-melting-point fibers (the content of the low-melting-point fibers is 5-50% by weight) in layer (b), and layer (a) is integrated with layer (b) by heat bonding the low-melting-point fibers.

Japanese Patent No. 2005-336407 A discloses a composite material excellent in surface smoothness, wherein said composite material comprises a fiber reinforced layer, a nonwoven fabric layer laminated on one or two surface of a fiber reinforced layer and a matrix resin impregnated into the formed laminate; wherein the fibers used in said fiber reinforced layer can be any fiber, preferably is carbon fibers, glass fibers and p-aromatic polyamide fiber; the fibers used in nonwoven fabric layer can be carbon fibers, glass fibers, p-aromatic polyamide fiber, boron fibers, metal fibers and the like. Of these fibers, carbon fibers and glass fibers are preferred. For consideration of the surface smoothness of the composite laminate, the nonwoven fibrous layer having a thickness of 0.05-0.5 mm, the fiber reinforced layer having a thickness of 0.2 mm or smaller, and the thickness ratio of nonwoven fiber layer and fiber reinforced layer is 0.5 or greater.

In the current published technical literature, although people have tried to use carbon fiber reinforced polymer material in combination with materials such as glass fibers, graphite fibers, aramid fibers, and the like, but has yet to find a composite material that can be desirable to improve its impact strength while keeping the thickness and weight of the material substantially unchanged.

### SUMMARY OF THE INVENTION

One aspect of the present invention is a composite laminate having improved impact strength, wherein said composite laminate comprises the following components, or substantially consists of the following components:

(a) a multilayer carbon fiber fabric, wherein said carbon fiber fabric may have a bidirectional weave or a unidirectional weave;

(b) a multilayer nonwoven mat, wherein said nonwoven mat is made of para-aramid; and

(b) cured epoxy resin;

wherein said cured epoxy resin is made of an epoxy resin system designed for impregnation in the carbon fiber fabric layer and at least one layer of the nonwoven mat is sandwiched between two layers of carbon fiber fabric layer and both outer surface layers of the composite laminate are carbon fiber fabric layer.

The present invention significantly improves the impact strength, the flexural strength and the flexural modulus of the product by forming a composite laminate using a carbon fiber reinforced polymer layer and a nonwoven mat made of para-aramid without changing the weight per unit area and the thickness of the final product.

According to another aspect of the present invention, a method of preparing a composite laminate having improved impact strength, wherein said method includes:

(i) providing a multilayer carbon fiber fabric and multilayer nonwoven mat, wherein said carbon fiber fabric may have a bidirectional weave or a unidirectional weave and said nonwoven mat is made of para-aramid;

(ii) impregnating said carbon fiber fabric layer with an epoxy resin system designed for impregnation;

(iii) locating at least one layer of impregnated carbon fiber fabric layer the first outer surface layer;

(iv) locating at least one layer of nonwoven mat and at least one layer of the impregnated carbon fiber fabric layer in an alternating manner until the total thickness of the composite laminate becomes 0.5-30 mm and wherein the second outer surface layer is an impregnated carbon fiber fabric layer in order to form a preform;

(v) placing the preform obtained in step (iv) into a mold and closing the mold;

(vi) optionally, applying a vacuum to said mold containing the preform to exclude air bubbles retained between the layers;

(vii) autoclaving the preform obtained in step (iv) and step (vi) for 0.5-12 hours (autoclave rated for 0.2-5.0 MPa at 50-200° C.) until said epoxy resin system designed for impregnation is cured; and

(viii) removing the preform from the mold when the temperature is dropped to room temperature in order to obtain the composite laminate.

Another aspect of the present invention is to provide parts and components of sporting goods equipment which comprises the composite laminate of the present invention, wherein said sports equipment includes tennis racquets, badminton racquets, squash racquets, composite parts of a bicycle, baseball bats, hockey sticks, snowboards, and sleds.

Another aspect of the present invention is to provide products and components of means of transport which comprises the composite laminate of the present invention, wherein said means of transport include cars, ships, trains, magnetic levitation trains, as well as aircraft.

### BRIEF DESCRIPTION OF THE DRAWINGS

FIG. 1 is a side sectional view of an embodiment of the composite laminate, in accordance with the present invention.

FIG. 2 is a partial sectional view of an embodiment of the composite laminate, in accordance with the present invention.

FIG. 3 is a partial sectional view of another embodiment of the composite laminate, in accordance with the present invention.

FIG. 4 is a partial sectional view of another embodiment of the composite laminate, in accordance with the present invention.

FIG. 5 is a partial sectional view of another embodiment of the composite laminate, in accordance with the present invention.

### DETAILED DESCRIPTION OF THE INVENTION

Unless otherwise defined, all technical and scientific terms used herein have the same meaning as commonly understood by one of ordinary skill in the art to which this invention pertains. In case of conflict, the present specification, including definitions, will control.

Whenever used, all percentages, parts and ratios are identified by weight unless otherwise indicated.

When an amount, concentration or other value or parameter is given as either a range, preferred range or a list of upper preferable values and/or lower preferable values, this is to be understood as specifically disclosing all ranges formed from any pair of any upper range limits or preferred values and any lower range limits or preferred values, regardless of whether the ranges are separately disclosed. When a range of numerical values is recited herein, unless otherwise stated, the range is intended to include the endpoints thereof, and all integers and fractions within the range.

In the present article, the term “formed by . . . ” or “constituted by . . . ” is synonymous to “comprising”. As used herein, the terms “comprises,” “comprising,” “includes,” “including,” “has,” “having,” “contains” or “containing,” or any other variation thereof, are intended to cover a nonexclusive inclusion. For example, a composition, process, method, article, or apparatus that comprises a list of elements is not necessarily limited to only those elements but may include other elements not expressly listed or inherent to such composition, process, method, article, or apparatus. Furthermore, unless expressly stated to the contrary, “or” refers to an inclusive “or” and not to an exclusive “or”. For example, a condition A “or” B is satisfied by any one of the following: A is true (or present) and B is false (or not present), A is false (or not present) and B is true (or present), and both A and B are true (or present).

### Carbon Fiber Fabric

The term “carbon fiber” refers to inorganic polymer fibers with carbon content higher than 90%, wherein, graphite fiber's carbon content is higher than 99%. Carbon fiber has high strength and modulus, no creep, good fatigue resistance, with specific heat and electrical conductivity between nonmetallic and metallic, low thermal expansion coefficient, good corrosion resistance, low fiber density, and good X-ray permeability. However, it has poor impact resistance, is easy to damage, and undergoes oxidation in strong acids. Therefore, carbon fiber should be subjected to surface treatment before use.

Carbon fibers may be used for rayon, pitch, phenolic aldehyde, polyvinyl alcohol, polyvinyl chloride, and other fibers. Especially, to make inorganic polymer fibers with high strength, high modulus and high temperature resistant, polyacrylonitrile (PAN) raw fiber is pre-oxidized and carbonized at 200-300° C. in air, then undergoes high temperature carbonization at 1000-2000° C. with inert gas protection and high temperature graphitization at 2500-3200° C., followed by final steps including surface treatment.

The term “bidirectional woven cloth” refers to any form of machine weave known to people skilled in this art, using continuous long filaments, and this type of weave usually is more stable than the unidirectional fabric, with its warp and weft having a considerable number of continuous filaments.

The term “unidirectional woven cloth” refers to fabric with greater than 80% of the continuous long fibers being arranged in parallel along the longitudinal direction (or warp), and in another direction (or weft), no or only less than 20% of continuous long fibers and usually spun and bond with spun yarn There are a variety of methods for weaving unidirectional cloth, including machine woven unidirectional fabric, unidirectional weftless fabric and stitch unidirectional cloth.

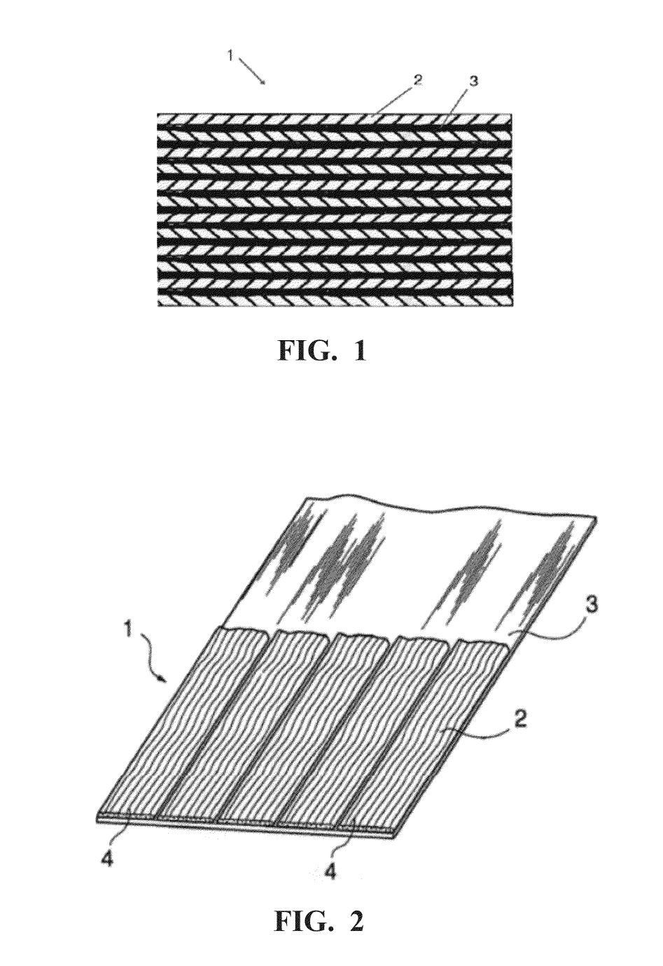

FIG. 1 is a side sectional view of an embodiment of the composite laminate of the present invention, wherein 1 represents a composite laminate, 2 represents a carbon fiber woven fabric containing a cured epoxy resin layer, and 3 represents a para-aramid nonwoven mat, wherein the carbon fiber woven fabric layers made with cured epoxy resin are alternately arranged with the nonwoven mat and the two outer surface layers of the composite laminate contain carbon fiber woven fabric layers made with cured epoxy resin.

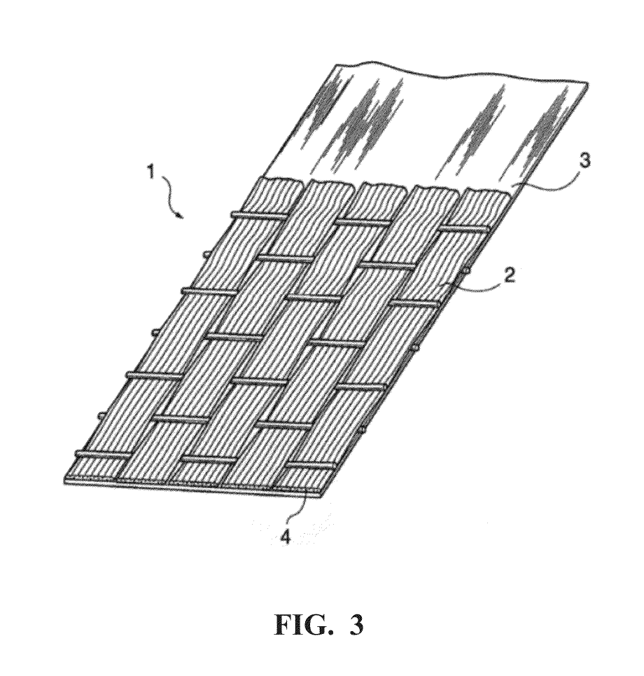

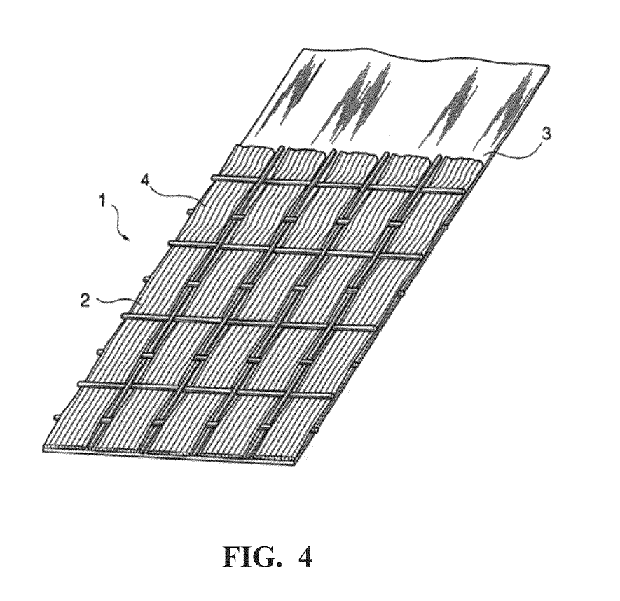

In the composite laminate of the present invention, there is no particular limitation toward the weaving style of the carbon fiber woven fabric. FIG. 2, FIG. 3 and FIG. 4 show the partial schematic views of the two alternating layers in some embodiment of the composite laminate of the present invention, wherein 1 represents a composite laminate, 2 represents carbon fiber woven fabric containing a cured epoxy resin layer, 3 represents a para-aramid nonwoven mat, and 4 represents carbon fiber. FIG. 2 shows that the carbon fiber woven fabric is a unidirectional weftless fabric, and FIGS. 3 and 4 show the carbon woven fabrics are two common noncrimp woven unidirectional cloths.

In some embodiments of the present invention, the thickness of the carbon fiber fabric layer is about 0.01-1.0 mm, or even about 0.05-0.5 mm.

The tensile strength of the carbon fiber woven fabric used in the present invention is in the range of about 1000-8000 MPa, preferably a tensile strength range of about 2000-5000 MPa. Its tensile modulus range is about 100-800 GPa, preferably about 200-400 GPa.

When the carbon fiber woven fabric is a bidirectional woven cloth, the weaving arrangement of each layer of carbon fiber fabric may be the same or different. When the carbon fiber woven fabric is a unidirectional fabric, the warp direction of the carbon fibers in each layer of carbon fiber fabric layer may be the same (0 degrees) or different (e.g., 90 degrees, +45 degrees, −45 degrees, etc.), and preferably each of the carbon fiber woven fabric layers is the same in the warp direction.

### Nonwoven Mat

The term “para-aramid” refers to a linear polymer constructed by binding para-aromatic groups with amide bonds or imide bonds, wherein at least 85% of the amide bonds or imide bonds are directly connected with the aromatic rings and when imide bonds exist, they do not exceed the number of amide bonds.

An example of the commercially available para-aramid is, but not limited to, Kevlar® products manufactured by E. I. du Pont de Nemours and Company Wilmington, Del. (DuPont).

The term “nonwoven mat is a warpless and weftless fabric, without spinning and weaving of fibers and has the advantage of lightweight and can be shaped easily. Its manufacturing process are usually to staple fibers or long filaments oriented or randomly on supporting column to form a fiber network structure, and then reinforced by mechanical, thermal bonding or chemical methods to make the product. Nonwoven products according to the different production processes can be categorized as the spunlaced, heat-sealable, air-laid, wet-laid, spun-bond, melt-blown, needled, stitch-bonded, etc.

In some embodiments of the present invention, the nonwoven mat in the composition of the present invention refers to a thin layer formed by methods known to technical persons skilled in the nonwoven process, using para-aramid staple fibers, wherein the nonwoven process, for example, includes but is not limited to, applying heat, tangles, stitches and/or pressure, etc. to form mesh or fluff using the para-aramid staple fiber.

In the composite laminate of the present invention, there is no particular limitation to the numbers of para-aramid nonwoven mat. In some embodiments of the present invention, the para-aramid nonwoven mat in the composite laminate of the present invention is 5-35 layers or even 10-25 layers.

In some embodiments of the present invention, the thickness of the para-aramid nonwoven mat used in the present invention is 0.005 mm to 0.10 mm or even 0.01 mm to 0.05 mm.

In the composite laminate of the present invention, the weight per unit area of each nonwoven mat layer may be the same or different. In some embodiments of the present invention, the weight per unit area of individual nonwoven mat is 5-40 g/m² or even 8-20 g/m².

### Epoxy Resin System for Impregnation Purpose

The composition laminate of the present invention contains cured epoxy resin. Said cured epoxy resin is made by the epoxy resin system impregnated in said carbon fiber woven fabric layer followed by curing. Said epoxy resin systems for impregnation refers to a curing system by adding curing agent, promoting agents, fillers and other auxiliary materials to epoxy resins, which is liquid under ambient or heated conditions. Epoxy resins generally refer to resins containing epoxy groups, mainly obtained by polycondensation of epichlorohydrin and phenols (such as bisphenol A), etc.

Epoxy resins used, for example, may include bisphenol-type epoxy resin, epoxy alcohols, hydrogenated phthalic acid-type epoxy resins, dimer epoxy resin, glycidyl-amino group containing epoxy resin, alicyclicepoxy resins, phenol-novolak type epoxy resins, cresol-novolak type epoxy resin, and novolak epoxy resin. Furthermore, a variety of modified epoxy resins can be utilized, such as urethane-modified epoxy resin and rubber-modified epoxy resin.

The present invention preferably uses bisphenol type epoxy resin, alicyclic epoxy resin, epoxy resin containing glycidyl-amino group, phenol-novolak type epoxy resins, cresol-novolak type epoxy resin, and urethane-modified epoxy resin.

Examples of bisphenol type epoxy resins include bisphenol A type resin, bisphenol F type resin, bisphenol-AD-type resin, and bisphenol S-type resin. More specific embodiments include the commercially available epoxy resins, for example, EP 815, EP 828, EP 834, EP 1001, and EP 807 manufactured by Yuka Shell Epoxy KK; Epomik R-710 manufactured by MITSUI PETROCHEMICAL and EXA 1514 by DIC.

Examples of the alicyclic epoxy resins include commercially available resins, such as Araldite CY-179, CY-178, CY-182 and CY-183 manufactured by HUNTSMAN.

Examples of epoxy resins containing glycidyl-amino include commercially available resins, such as MY-720 by Ciba-Geigy; Epototo YH 434 by Tohto Kasei Co., Ltd.; EP 604 by Yuka Shell Epoxy KK; ELM-120 and ELM-100 by Sumitomo Chemical Co., Ltd. and GAN by Nippon Kayaku Co., Ltd.

Examples of phenol-novolak type epoxy resins include EP152 and EP 154 by Yuka Shell Epoxy KK, DEN 431, DEN 485 and DEN 438 by Dow Chemical and EPICLON N 740 by Dainippon Ink and Chemicals, Incorporated.

Examples of cresol-novolak type epoxy resins include ECN1235, ECN 1273 and ECN 1280 by HUNTSMAN and EOCN102, EOCN 103 and EOCN 104 by NIPPON KAYAKU Co., Ltd.

In addition, examples of the urethane-modified bisphenol A type epoxy resins include Adeka Resin EPU-6 and EPU-4 by Asahi Denka Kogyo KK.

These epoxy resins may be used individually or in appropriate combinations of two or more kinds. Among them, bifunctional epoxy resins such as bisphenol type epoxy resin, depending on its molecular weight, there may be products with different grades ranging from liquid to solid. By properly combining different grades of bisphenol type epoxy resin, the final viscosity of the impregnated epoxy system can be adjusted.

In the composition laminate of the present invention, said carbon fiber woven fabric layers are dipped in the epoxy resin system for impregnation purpose, to form the impregnated carbon fiber fabric layer. Said impregnation refers to the epoxy resin system uniformly or partially immersed in the carbon fiber woven fabric layer and said impregnation epoxy resin system can be immersed in either the whole or part of the thickness of the layer of carbon fiber fabric.

Based on the total weight of the impregnated carbon fiber fabric layer, the impregnation epoxy resin system accounts for 10-80 wt %, or even 20-70 wt %, or even 30-45 wt %.

The impregnated carbon fiber fabric layer in the composite laminate of the present invention can be obtained by impregnating the carbon fiber woven fabric layer in one or more types of the epoxy resin system, as described above. The impregnated carbon fiber fabric layers can also be purchased directly, commonly referred to as pre-pregs. Said pre-pregs can skip two steps including preparation of the impregnation epoxy resin system and the impregnation of the carbon fiber fabric layer, which is a time-saving alternative material.

In other embodiments of the present invention, the above-mentioned composite laminate includes the following ingredients or is basically composed by the following components or is prepared by the following mixtures:

a multilayer prepreg layer, which comprises a carbon fiber impregnated with epoxy resin; the carbon fiber woven fabric mentioned above is either a bidirectional cloth or an unidirectional cloth.

a multilayer nonwoven mat, which is made of polyparaphenylene terephthalamide; at least one layer of the non-woven mat is sandwiched between two prepreg layers and two outer surface layers of the composite laminate are said prepreg layer.

In the present invention, the above-mentioned epoxy resin system used for impregnation is first impregnated into the carbon fiber fabric layer, and then the impregnated carbon fiber fabric layer with epoxy resin is laminated with the nonwoven mat, then cured and included in the composite laminate.

In the composite laminate mentioned in the present invention, the thickness of each layer of the impregnated carbon fiber fabric layer or the prepreg layer can be the same or different. In some embodiments of the present invention, each of the impregnated carbon fiber fabric layer or the prepreg layer is independent. The thickness of each impregnated carbon fiber fabric layer or the prepreg layer is about 0.001-1.00 mm or even about 0.05-0.5 mm.

In the composite laminate mentioned in the present invention, the weight of each layer of the impregnated carbon fiber fabric layer or the prepreg layer can be the same or different. In some embodiments of the present invention, each of the impregnated carbon fiber fabric layer or the prepreg layer is independent. The weight per unit area of each impregnated carbon fiber fabric layer or prepreg layer is about 50-660 g/m², or even about 80-300 g/m², or even about 90-200 g/m².

In the composite laminate mentioned in the present invention, there is no restriction on the number of layers for the impregnated carbon fiber fabric layer or the prepreg layer. In some embodiments of the present invention, the number for layers of the impregnated carbon fiber fabric layer or the prepreg layers in the composite laminate is about 10-40 layers and preferably 15-30 layers.

The composite laminate could include an alternative placement of a single layer of the carbon fiber fabric layer and a single layer of the nonwoven mat. It could also include an alternative placement of multiple layers of the carbon fiber fabric layer and a single layer of the nonwoven mat, or an alternative placement of a single layer of the carbon fiber fabric layer and multilayers of the nonwoven mat. It could also include an alternative placement of a multilayer carbon fiber fabric layer and at least more than one layer of the nonwoven mat placed between the two layers of carbon fiber fabric layers. Both of the outer layers of such a composite laminate should be the prepreg layer. In this circumstance, the “carbon fiber woven fabric layer” is equivalent to the “impregnated carbon fiber fabric layer or the “prepreg layer.

In some embodiments of the present invention, the total weight of the composite laminate is distributed as follows: the carbon fiber woven layer and the impregnated epoxy resin are accounting for 85-95%, preferably 90-95%; the polyparaphenylene terephthalamide multilayer non-woven mat is accounting for 5-15% of the total weight, preferably 5-10%.

In some embodiments of the present invention, the ratio of thickness for the polyparaphenylene terephthalamide multilayer non-woven mat over the cured epoxy resin layer is 0.2 or les.

The present invention also provides a method for making a composite laminate with improved impact resistance characteristics, including:

(i) providing a multilayer carbon fiber fabric layer and a multilayer non-woven mat, where the multilayer carbon fiber fabric has bidirectional or unidirectional fibers and the multilayer non-woven mat is made of polyparaphenylene terephthalamide;

(ii) dipping the multilayer carbon fiber fabric layer a with a impregnating epoxy resin system to obtain an impregnated carbon fiber woven fabric layer;

(iii) locating at least one layer of the impregnated carbon fiber fabric layer as a first outer surface layer;

(iv) locating in an alternative manner with at least one layer of nonwoven mat and at least a layer of impregnated carbon fiber fabric layer until the total thickness of the composite laminate reaches 0.5-30 mm. The second outer layer is also impregnated carbon fiber fabric layer to make a preform.

(v) placing the preform made in step (iv) into a mold, and closing the mold;

(vi) optionally applying a vacuum to the preform to exclude bubbles left at the interlayer;

(vii) autoclaving the preform in step (v) or (iv) at 50-200° C., 0.2-5.0 MPa for 0.5-12 hours until the impregnated epoxy resin system becomes cured; and

(viii) stripping the derived composite laminate once the temperature is lowered to room temperature

For step (vii) in the method of making composite laminate with improved impact resistance characteristics, the temperature for the heat pressure treatment can be 50-200° C. or 80-150° C. and the pressure for the heat pressure treatment can be 0.2-5.0 MPa or 0.5-2.5 MPa.

The present invention utilized a composite laminate formed by the right-aromatic polyamide composition of the non-woven mat and the carbon fiber reinforced prepreg layers to achieve the improvement of the impact strength of the final product, while maintaining the thickness and weight of the final product is substantially unchanged.

Compared to other carbon fiber reinforced polymer laminates made of para-aramid composition, which does not contain the present invention, at the same layer thickness and unit weight conditions, the composite layer of the present invention compositions (i.e. in the non-woven mat is sandwiched between layers of carbon fiber fabric impregnated with epoxy resin system and curing said epoxy resin system compound) in 20-45% of the impact strength significantly improved, 3-11.7% increase in the bending strength, and 3-7.1% increase in the flexural modulus.

Moreover, the composite laminate of the present invention can be treated like ordinary carbon fiber prepreg heat molding or other processing. The description of the various embodiments of the present invention described herein can be performed in any combinations and various embodiments that are not only suitable for said composite laminate, but also suitable for the preparation method of the composite laminate and its manufacturing parts.

### EXAMPLES

Next, the present invention will be descripted in more detail by the way of an example. Of note, the material of the present invention, methods, and embodiments described in the following example are for explanation purpose notice only, not restrictive.

Material

a) Unidirectional Carbon Fiber Cloth Prepreg
Purchased from WuXi Tianniao Composites Company. The weight per unit area is 185 g/m², including 120 g/m² of carbon fiber unidirectional cloth. The bulk density of this carbon fiber unidirectional cloth is 1.8 g/cm³, and the thickness is 0.067 mm. It is impregnated with epoxy resin system.

b) Para-Aromatic Polyamide Nonwoven Mat
Made of short Kevlar® fibers by prepared by a chemical method, weight per unit area is 15 g/cm². The bulk density of this nonwoven mat is 1.8 g/cm³ and the thickness is 0.01 mm.

c) Nylon Non-Woven Mat
Made of short nylon fiber (from WuXi Belt Rubber Belts Co., Ltd.) through manual placement SYSTEM 13NTD81835 to make the non-woven mat. The nonwoven mat has a weight per unit area of 15 g/m², a volume density of 1.14 g/cm³ and a thickness of 0.01 mm.

### Test Method:

The flexural strength and flexural modulus of the laminate samples of embodiments and comparative examples were tested according to standards in GB/T 3356-99;

The average unnotched Charpy impact strength of the laminate samples of embodiments and comparative examples were determined using Resil Impactor instrument according to standards in ISO 179.

### Comparative Example 1

A unidirectional carbon fiber pre-impregnated sheet with the weight per unit area of 185 g/m² was cut into sheets about 300 mm×300 mm and 14 layers of this pre-impregnated sheet were stacked together according to the same fiber orientation (meridional) in order to prepare laminate preforms. The preform was placed on a flat aluminum mold and the mold was then transferred to a pressing machine which was preheated to 130° C., the mold was closed (i.e. closed by a clamping mechanism) and a pressure of 1.0 MPa was applied to the mold. The laminate preform was maintained at 130° C. for 1 hour, then the heat treatment was stopped and the samples were cooled to room temperature. The carbon fiber reinforced polymer laminate was removed from the mold, and the final thickness of the laminate was measured to be 1.746 mm.

### Example 1

A unidirectional carbon fiber pre-impregnated sheet with the weight per unit area of 185 g/m² was cut into sheets about 300 mm×300 mm. Kevlar® nonwoven mat with a weight per unit area of 15 g/m² was also cut into sheets about 300 mm×300 mm. A layer of the pre-impregnated sheet (i.e. the impregnated carbon fiber fabric layer) was placed first as the surface of the first outer layer and then a layer of the nonwoven mat and another layer of the pre-impregnated sheet were placed in an alternating manner so that the Kevlar® nonwoven mat was sandwiched between the two layers of the pre-impregnated sheet. Each pre-impregnated sheet was stacked together according to the same fiber orientation (meridional) and a total of 12 layers of the pre-impregnated sheet and 11 layers of Kevlar® nonwoven mat were used for the preparation of the composite laminate preform consisting of Kevlar® nonwoven mats and carbon fiber reinforced polymers. The preform was placed on a flat aluminum mold and the mold was then transferred to a pressing machine which was preheated to 130° C., the mold was closed (i.e. closed by a clamping mechanism) and a pressure of 1.0 MPa was applied to the mold. The preform was maintained at 130° C. for 1 hour, then the heat treatment was stopped and the samples were cooled to room temperature. The composite laminate preform consisting of Kevlar® nonwoven mats and carbon fiber reinforced polymers was removed from the mold and the final thickness of the laminate was measured to be 1.742 mm.

### Comparative Example 2

Using the method similar to that of Comparative Example 1, 31 layers of the carbon fiber pre-impregnated sheet with a size of 150 mm×150 mm were used in the preparation of the carbon fiber reinforced polymer laminate in which the final thickness was measured to be 3.674 mm.

### Example 2

Using the method similar to that of Example 1, 26 layers of the carbon fiber pre-impregnated sheet with a size of 150 mm×150 mm and 25 layers of Kevlar® nonwoven mat with a size of 150 mm×150 mm were used in the preparation of the carbon fiber reinforced polymer composite laminate in which the final thickness was measured to be 3.662 mm. A layer of the pre-impregnated sheet was placed first as the surface of the first outer layer, and then a layer of nonwoven mat and a layer of pre-impregnated sheet were placed in an alternating manner so that a Kevlar® nonwoven mat is sandwiched between the two layers of pre-impregnated sheet. Each pre-impregnated sheet was stacked together according to the same fiber orientation (meridional).

### Comparative Example 3

Using the method similar to that of Example 2, 26 layers of the carbon fiber pre-impregnated sheet with a size of 150 mm×150 mm and 25 layers of a nylon nonwoven mat with size of 150 mm×150 mm were used in the preparation of the carbon fiber reinforced polymer composite laminate in which the final thickness was measured to be 3.709 mm. A layer of the pre-impregnated sheet was placed first as the surface of the first outer layer, and then a layer of Nylon nonwoven mat and a layer of pre-impregnated sheet were placed in an alternating manner so that there was a nylon nonwoven mat sandwiched between the two layers of pre-impregnated sheet. Each pre-impregnated sheet was stacked together according to the same fiber orientation.

### Sample Testing

a) The laminate samples obtained from Comparative Example 1 and Example 1 with a length of 300 mm, a width of 300 mm and respective thicknesses of 1.746 mm and 1.742 mm were tested for flexural strength and flexural modulus.

b) The laminate samples obtained from Comparative Example 2, Comparative Example 3 and Example 3 with a length of 150 mm, a width of 150 mm and respective thicknesses of 3.674 mm, 3.709 mm and 3.662 mm were tested for impact strength.

The results of these tests are shown in Table 1 and Table 2.

TABLE 1
Structure of the carbon fiber reinforced polymer laminate
as well as its flexural strength and flexural modulus

| | | Average | Weight | | |
|---|---|---|---|---|---|
| | | thick- | of the | Flexural | Flexural |
| | | ness | laminate | strength | modulus |
| Example | Structure | (mm) | (g) | (MPa) | (GPa) |
| Example 1 | 12 layers of | 1.742 | 256.11 | 1542 | 111.41 |
| | carbon fiber | | | | |
| | pre-impregnated | | | | |
| | sheet + | | | | |
| | 11 layers of | | | | |
| | para-aramid | | | | |
| | nonwoven mat | | | | |
| Compar- | 14 layers of | 1.746 | 254.50 | 1380 | 103.99 |
| ative | carbon fiber | | | | |
| Example 1 | pre-impregnated | | | | |
| | sheet | | | | |

TABLE 2
Structure of the carbon fiber reinforced polymer
laminate as well as its impact strength

| | | Average | Weight | |
|---|---|---|---|---|
| | | thick- | of the | Impact |
| | | ness | laminate | strength |
| Example | Structure | (mm) | (g) | (kJ/m²) |
| Embodiment | 26 layers of carbon fiber | 3.662 | 139.81 | 164.1 |
| 2 | pre-impregnated sheet + | | | |
| | 25 layers of para-aramid | | | |
| | nonwoven mat | | | |
| Compar- | 31 layers of carbon fiber | 3.674 | 139.7 | 112.9 |
| ative | pre-impregnated sheet | | | |
| Example 2 | | | | |
| Compar- | 26 layers of carbon fiber | 3.709 | 140.82 | 149.2 |
| ative | pre-impregnated sheet + | | | |
| Example 3 | 25 layers of Nylon | | | |
| | nonwoven mat | | | |

It can be seen from the above test results that the addition of para-aramid nonwoven mat has effectively improved the flexural strength and flexural modulus of the carbon fiber reinforced polymer composite laminate with the same thickness. Although the thickness and quantification of Example 1 and Comparative Example 1 are very similar, the flexural strength of the sample of Example 1 has been improved by 11.7% and flexural modulus has been improved by 7.1% compared to the sample of Comparative Example 1.

It can be seen from the impact strength test results that the addition of the para-aramid nonwoven mat has effectively improved the impact strength of the carbon fiber reinforced polymer composite laminate. Example 2 and the Comparative Example 2 have similar weight and thickness, but the impact strength of Example 2 has been increased by 45.3% compared to Comparative Example 2. In addition, when compared Comparative Example 2, Example 2 used only 26 layers of the carbon fiber pre-impregnated sheet which means 16.1% of carbon fiber pre-impregnated sheets were saved, and it has surprisingly been found that an unexpectedly great improvement of the impact strength is achieved.

In addition, although Example 2 and Comparative Example 3 have a similar weight and thickness, the impact strength of Example 2 has also been increased by 10% compared to Comparative Example 3. This shows that the use of para-aramid nonwoven mat has effectively improved the impact strength of carbon fiber reinforced polymer composite laminate comparing to the nylon nonwoven mat with similar weight and thickness.

Although the present invention has specifically been described based on typical exemplary embodiments, the present invention is not limited to these examples but may be modified as appropriate without departing from the scope of the invention. Therefore, it will be appreciated by those skilled in the art that various modifications and equivalent embodiments be made in these embodiments, and that various modifications and equivalent embodiments be made without departing from the spirit and scope of the invention.

1. A composite laminate having improved impact strength, which comprises:
(a) a multilayer carbon fiber fabric, wherein said carbon fiber fabric may be a bidirectional weave or a unidirectional weave;
(b) a multilayer nonwoven mat, wherein said nonwoven mat is made of para-aramid; and
(c) cured epoxy resin;
wherein said cured epoxy resin is made of an epoxy resin system designed for impregnation is impregnated in the carbon fiber fabric layer and at least one layer of the nonwoven mat is sandwiched between two layers of carbon fiber fabric layer.

2. The composite laminate in accordance with claim 1, wherein said composite laminate has a total thickness of 0.5 mm to 30 mm, or 1.0 mm to 10 mm, or 1.5 mm to 5 mm.

3. The composite laminate in accordance with claim 1, wherein the total weight of the carbon fiber fabric layer and cured epoxy resin is from 85 to 95% of the total weight of the composite laminate; and the weight of said multilayer nonwoven mat is from 5 to 15% of the total weight of the composite laminate.

4. The composite laminate in accordance with claim 1, wherein the epoxy resin of said epoxy resin system designed for impregnation selected from the group consisting of bisphenol-type epoxy resin, alicyclic epoxy resin, epoxy resin containing glycidyl and amino groups, phenol novolac type epoxy resin, benzene cresol novolac type epoxy resin and urethane modified epoxy resin.

5. The composite laminate in accordance with claim 1, wherein the weight per unit area of each layer of impregnated carbon fiber fabric layer independently represent 50-660 g/m², or 80-300 g/m² or 90-200 g/m².

6. The composite laminate in accordance with claim 1, wherein the weight of epoxy resin system designed for impregnation is from 10 to 80% of the total weight of said impregnated carbon fiber fabric layer or 20 to 70%, or 30 to 45%.

7. The composite laminate in accordance with claim 1, wherein the weight per unit area of each layer of said nonwoven mat independently represents 5-40 g/m², or 8-20 g/m².

8. A method of preparing a composite laminate having improved impact strength comprises:
(i) providing a multilayer carbon fiber fabric and multilayer nonwoven mat wherein said carbon fiber fabric may be a bidirectional weave or a unidirectional weave and said nonwoven mat is made of para-aramid;
(ii) impregnating said carbon fiber fabric layer with an epoxy resin system designed for impregnation;
(iii) locating at least one layer of impregnated carbon fiber fabric layer as a first outer surface layer;
(iv) locating at least one layer of nonwoven mat and at least one layer of the impregnated carbon fiber fabric layer as a second outer surface layer in an alternating manner until the total thickness of the composite laminate becomes 0.5-30 mm to form a preform;
(v) placing the preform obtained in step (iv) into a mold and closing the mold;
(vi) optionally, applying a vacuum to said mold containing the preform to exclude air bubbles retained between the layers;
(vii) autoclaving the preform obtained in step (iv) and step (vi) for 0.5-12 hours (autoclave rated for 0.2-5.0 MPa at 50-200° C.) until said epoxy resin system designed for impregnation is cured; and
(viii) removing the preform from the mold when the temperature is dropped to room temperature in order to obtain the composite laminate.

9. The composite laminate in accordance with claim 1 used for parts and components of sporting goods equipment, wherein said sporting goods equipment includes tennis racquets, badminton racquets, squash racquets, composite parts of a bicycle, baseball bats, hockey sticks, snowboards and sleds.

10. The composite laminate in accordance with claim 1 used for products and components of means of transport, wherein said means of transport includes cars, ships, trains, magnetic levitation trains and aircraft.

11. The use of composite laminate in accordance with claim 1 in the preparation of sporting goods equipment, wherein said sporting goods equipment includes tennis racquets, badminton racquets, squash racquets, composite parts of a bicycle, baseball bats, hockey sticks, snowboards and sleds.

12. The use of composite laminate in accordance with claim 1 in the preparation of products and components of means of transport, wherein said means of transport includes cars, ships, trains, magnetic levitation trains and aircraft.
